(19) United States
(12) Patent Application Publication
(10) Pub. No.: US 2009/0153442 A1
(43) Pub. Date: Jun. 18, 2009

(54) Plasma Display Apparatus

(75) Inventors: Katsunobu KIMURA, Yokohama (JP); Takaaki Nishiseto, Yokohama (JP); Yuichiro Kimura, Yokohama (JP); Kiyoshi Takata, Machida (JP); Hideaki Ohki, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/244,218

(22) Filed: Oct. 2, 2008

(30) Foreign Application Priority Data
Dec. 17, 2007 (JP) 2007-324180

(51) Int. Cl. G09G 3/28

(52) U.S. Cl. 345/63

(57) ABSTRACT

According to the invention, by forming at least every two frames having video contents corresponding to each frame of a video signal, for example, a frame rate of movie contents whose frame rate is equal to 24 Hz is converted into 48 Hz. A plurality of subfields (SFs) corresponding to each frame of the conversion signal are divided into first and second division SF groups. Each division SF group is further classified into an upper SF group on the large weight side and a lower SF group on the small weight side. The weights of the upper SF groups are made symmetrical between the first and second division SF groups. The weight of each SF belonging to the lower SF group in the first division SF is set to be larger than that in the second division SF.

### INCORPORATION BY REFERENCE

The present application claims priority from Japanese application JP2007-324180 filed on Dec. 17, 2007, the content of which is hereby incorporated by reference into this application.

### BACKGROUND OF THE INVENTION

The invention relates to a plasma display apparatus for performing a gradation display by forming a plurality of subfields having different weights from one frame of a video signal and, more particularly, to a plasma display apparatus in which a technique to form subfields suitable to display movie contents has been made.

In a plasma display apparatus, the gradation display is performed by what is called a subfield display system. According to the subfield display system, a plurality of subfields added with weights corresponding to the nth power of 2 (n=0, 1, 2, . . . ) are formed from one frame of a video signal and discharge maintaining pulses (hereinbelow, also referred to as sustaining pulses) specified by the weight are applied every subfield to discharge cells constructing a plasma display panel (hereinbelow, abbreviated to a PDP), thereby expressing a gradation according to a visual integrating effect.

Since the plasma display apparatus has such a construction as mentioned above, when a vertical frequency (frame/field frequency) of the video signal is low, a flicker becomes conspicuous. As a related art to reduce such a flicker, for example, the technique disclosed in JP-A-2000-66630 has been known. It discloses such a technique that with respect to a video signal of 50 Hz, a subfield corresponding to one video frame is divided into two subfield groups, upper subfields in the respective subfield groups are made to coincide with each other, and further, lower subfield groups are made to differ from each other.

### SUMMARY OF THE INVENTION

In JP-A-2000-66630, a consideration is made only to the video signal whose vertical frequency (frame/field frequency) is equal to 50 Hz based on the PAL system, SECAM system, or the like and no consideration is made with respect to, for example, a video signal of a movie contents whose frame frequency is equal to 24 Hz.

In order to display the video signal whose frame rate (frame frequency) is equal to 24 Hz to the PDP without making a flicker conspicuous, there is a method whereby by forming, for example, every three or four frames of the same video contents as those of each frame in the video signal, the frame rate is converted into 72 Hz or 96 Hz. However, if the frame rate of the video signal is raised, a period of one frame is shortened and the number of subframes which can be used per frame decreases, so that sufficient gradations cannot be obtained. In the case of forming every two frames of the same video contents and converting the frame rate into 48 Hz, since the frame rate is smaller than 50 Hz, the flicker increases.

What is called a telecine signal in which 24 movie films per second have been 2-3 pull-down processed and the frame rate has been converted into 60 Hz is known as a video signal of the movie contents. According to the telecine signal, since each frame is repeated by the 2-3 pull-down process in such a manner that two frames, three frames, two frames, . . . are repetitively displayed, a period of time during which a video image comes to rest is also repeated like 2/60 second, 3/60 second, and 2/60 second. Therefore, according to the telecine signal, a motion judder (jaggy feeling of a motion) caused by a change in still period of time of the video image occurs. In JP-A-2000-66630, no consideration is also made with respect to the motion judder.

Even in the case where the movie contents is viewed by a home-use display apparatus such as a television display apparatus or the like, it is desirable that the movie contents can be viewed so that a visual effect similar to that in the case of viewing it in a movie theater, that is, it can be viewed at a high presence. In JP-A-2000-66630, no consideration is also made with respect to such a problem.

The invention is made in consideration of the above problems and provides such a technique that even in the case where a video signal of a low frame rate such as a movie contents is displayed on the PDP, good gradations can be obtained and a large flicker can be suppressed. The invention also provides such a technique that the movie contents can be viewed at a high presence.

The invention is characterized by having constructions disclosed in claims. That is, according to the invention, by forming at least every two frames having video contents corresponding to each frame of a video signal, for example, a frame rate of a movie contents whose frame rate is equal to 24 Hz is converted into 48 Hz. A plurality of subfields corresponding to each frame of the conversion signal is divided into first and second division subfield groups, and each division subfield group is further classified into an upper subfield group on the side where a weight of a luminance is large and a lower subfield group on the side where a weight of a luminance is small. A weight of the upper subfield group in the first division subfield group and a weight of the upper subfield group in the second division subfield group are equalized or made symmetrical. A weight of each subfield belonging to the lower subfield group in the first division subfield group is set to be larger than a weight of each subfield belonging to the lower subfield group in the second division subfield group.

Thus, for example, when the frame rate of the inputted video signal is equal to 24 Hz, since the subfields can be formed, for example, at a period of time of 1/48 second per frame, the subfields of the number per frame necessary to obtain good gradations can be assured. Since the weights of the upper subfield groups on the large weight side are equalized or made symmetrical between the two division subfields, the subfields of the high gradation can be formed at a frequency of 96 Hz and the flicker can be suppressed. Further, in each of the first and second division subfield groups, since the weights of the respective subfields belonging to the lower subfield group on the small weight side are made differ, in the case of displaying the movie contents in which the number of dark video images is relatively large, the gradations of the dark video images can be improved.

According to the invention, even in the case where, for example, the video signal whose frame rate is low like a movie contents is displayed on the PDP, the good gradations can be obtained and the video images can be displayed while suppressing the large flicker.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an embodiment of a plasma display apparatus according to the invention;

FIG. 2 is a diagram showing a state of a telecine conversion;

FIG. 3 is a diagram showing an example of a telecine phase detection;

FIG. 4 is a diagram showing a state of a telecine IP conversion;

FIG. 5 is a diagram showing a state of a frame repeating process;

FIG. 6 is a diagram showing an example of a form of a frame according to a smooth cinema process;

FIG. 7 is a diagram showing an example of a detection of a motion vector;

FIG. 8 is a diagram showing an example of a menu display screen for selecting a cinema mode;

FIG. 9 is a diagram for explaining a principle of the invention;

FIG. 10 is a diagram showing an example of subframe control in the embodiment;

FIG. 11 is a diagram showing an example of a state of a subframe group in the embodiment;

FIG. 12 is a diagram showing frequency components of video images displayed by the embodiment;

FIG. 13 is a diagram showing the second embodiment of the invention and showing another example of an asymmetrical SF control unit 131; and

FIGS. 14A, 14B, and 14C are diagrams showing examples of subfields which are formed by the asymmetrical SF control unit 131 in the second embodiment.

### DETAILED DESCRIPTION OF THE INVENTION

An embodiment of the invention will be described hereinbelow with reference to the drawings. In each diagram, elements having common functions or operations are designated by the same reference numerals and an overlapped explanation is omitted with respect to the component elements which have been described once.

### Embodiment 1

According to the embodiment, as for a video signal of a movie contents or the like whose frame rate is equal to 24 Hz, first, every two frames of such a video signal are repeated (every two frames of the same video contents as those of each frame are formed), thereby converting (doubling) the frame rate into 48 Hz. The embodiment is characterized as follows. A plurality of subfields which are formed in correspondence to each frame of the doubled signal is divided into first and second division subfield groups. Further, each division subframe group is classified into an upper subframe group on the side where a weight of a luminance is large and a lower subframe group on the side where a weight of a luminance is small. The weight of each subfield belonging to the upper subframe group in the first division subfield group and the weight of each subfield belonging to the upper subframe group in the second division subfield group are made symmetrical. The weight of each subfield belonging to the lower subfield group in the first division subfield group and the weight of each subfield belonging to the lower subfield group in the second division subfield group are made asymmetrical. Such forming control of the subframes is called “asymmetrical SF control” hereinbelow. There is also a case where the subframe is called “SF” hereinbelow. There is also a case where the weight of the luminance to the SF is simply called “weight”.

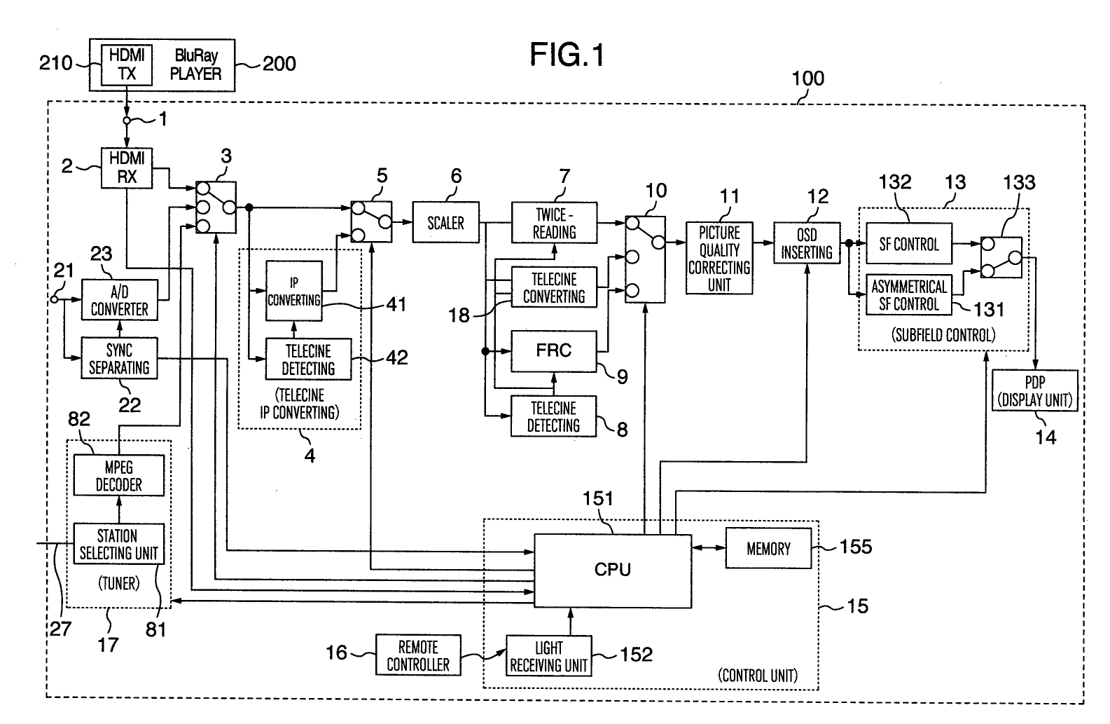

First, an example of a plasma display apparatus according to an embodiment of the invention will be described with reference to FIG. 1. A plasma display apparatus 100 according to the embodiment will be described with respect to a television receiver, as an example, which can receive, for example, a television broadcasting signal. The plasma display apparatus 100 can input video signals from several video sources. One of them is a television broadcasting signal (for example, BS/CS/terrestrial television signal: hereinbelow, simply referred to as a TV signal) which has been received by an antenna (not shown) and transmitted by, for example, a coaxial cable 27. In the embodiment, it is assumed that the TV signal is a digital TV signal transmitted by a digital television broadcasting. Another video signal is a video signal of an analog format which is inputted to an analog input terminal 21 and is reproduced by, for example, a DVD, VTR, or the like. Further another video signal is a video signal of a digital format which is inputted to a digital input terminal and is reproduced by, for example, an external video reproducing apparatus 200 such as Blu-ray player, HDD recorder, or the like. It is assumed that each element of the plasma display apparatus 100 is controlled by a CPU 151 in accordance with software such as an OS or the like stored in a memory 155 in a control unit 15.

Several formats exist for the video signals which are inputted to the plasma display apparatus 100. For example, there are: a video signal of a normal format (instead of the pull-down format) whose vertical frequency, that is, frame frequency (hereinbelow, this frequency is called “frame rate”) is equal to 60 Hz; a telecine signal of the 2-3 pull-down format whose frame rate is equal to 60 Hz; a signal such as animation, movie contents, or the like whose frame rate is equal to 24 Hz; and the like. As a video signal having a frame rate of 24 Hz, for example, there is a video signal based on the video contents such as movie or animation reproduced from a Blu-ray disc. In the case where the video signal is transmitted by an interface according to a special standard (HDMI: High Definition Multimedia Interface), the video signal having the frame rate of 24 Hz can be inputted to the plasma display apparatus 100. Explanation will be made hereinbelow on the assumption that the video signal having the frame rate of 24 Hz or the telecine signal is inputted to the plasma display apparatus 100. Since the video signal whose frame rate is equal to 24 Hz and which is inputted to the plasma display apparatus 100 as mentioned above has a progressive (sequential operation) format, there is also a case where this signal is referred to “24p signal”.

The external video reproducing apparatus 200 is connected to a digital input terminal 1 of the plasma display apparatus 100 by the interface (HDMI interface) according to the foregoing HDMI standard. The external video reproducing apparatus 200 is, for example, a Blu-ray player. In the case where a Blu-ray disc on which a movie contents has been recorded is reproduced by the Blu-ray player and the Blu-ray player has been connected to the plasma display apparatus 100 by the HDMI interface, a 24p signal is formed. The 24p signal is transmitted by an HDMI transmitter 210 of the external video reproducing apparatus 200. The 24p signal from the HDMI transmitter 210 is inputted to the digital input terminal 1 through the HDMI interface and received by an HDMI receiver 2. The signal received by the HDMI receiver 2 is supplied to one contact of an input change-over switch 3. In the embodiment, the input change-over switch 3 has three contacts. As mentioned above, one of them corresponds to the signal from the HDMI receiver 2, another one corresponds to the signal inputted to the analog input terminal 21, and further another one corresponds to a TV signal received by a tuner 17. The analog video signal outputted from an external video apparatus such as DVD player, VTR, or the like is inputted to the analog input terminal 21. The analog video signal is separated into a video signal and a sync signal by a sync separating circuit 22 and, at the same time, converted into a digital signal by an A/D converter 23 on the basis of sampling clocks formed by the sync separating circuit 22 by using the sync signal as a reference. The video signal converted by the A/D converter 23 is supplied to another contact of the input change-over switch 3.

The TV signal which has been received by the antenna (not shown) and transmitted by the cable 27 is received by the tuner 17. It is assumed here that the TV signal has been compression-encoded by, for example, MPEG2. Under control of the CPU 151 constructing the control unit 15, a station selecting unit 81 of the tuner 17 selects a desired broadcasting channel included in the broadcasting signal (RF signal) received by the antenna, demodulates, and outputs a TS (Transport Stream) to which various kinds of data have been multiplexed. An MPEG decoder 82 executes a decoding process to the TS, forms a non-compression digital video signal, and supplies to further another contact of the input change-over switch 3.

The input change-over switch 3 selects one of the video signals supplied to the three contacts according to a control signal from the control unit 15 and outputs. The signal selected by the input change-over switch 3 is supplied to one contact of a switch 5 and is also supplied to a telecine IP converting circuit 4.

In the case where an output signal from the input change-over switch 3 is a telecine signal of an interlace format, the telecine IP converting circuit 4 is a circuit element for converting the output signal into a signal of a progressive format. The telecine IP converting circuit 4 includes: a telecine detecting unit 42 for detecting whether or not the output signal from the input change-over switch 3 is the telecine signal; and an IP converting unit 41 for converting the telecine signal of the interlace format into the telecine signal of the progressive format.

The telecine detecting unit 42 detects whether or not the inputted video signal is the telecine video signal of the 2-3 pull-down format.

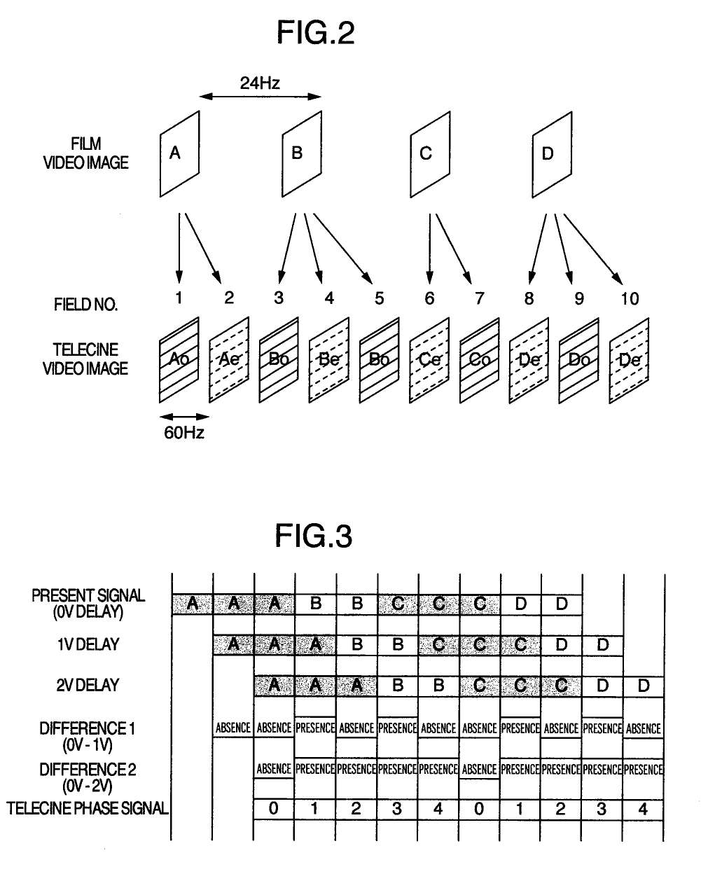

To explain the telecine detecting operation which is executed by the telecine detecting unit 42, first, the telecine signal of the 2-3 pull-down format will be described with reference to FIG. 2. It is now assumed that the telecine signal is based on the interlace format. In FIG. 2, a field No. differs from an actual field No. and is an expedient field No. for convenience of explanation.

On the broadcasting station side, as shown in FIG. 2, with respect to a film video image (film source) in which the number of frames per second is equal to 24, the following conversion is sequentially executed: for example, video images of two fields of a first field Ao (“o” is a suffix indicative of the odd-number designated field) and a second field Ae (“e” is a suffix indicative of the even-number designated field) are formed from a video image A of the first frame; video images of three fields of a third field Bo, a fourth field Be, and a fifth field Bo are formed from a video image B of the second frame; subsequently, in a manner similar to the above, video images of two fields of a sixth field Ce and a seventh field Co are formed from a video image C of the third frame; and video images of three fields of an eighth field De, a ninth field Do, and a tenth field De are formed from a video image D of the fourth frame. By the 2-3 pull-down process, the film video signal of 24 Hz (24 frames/sec) is converted into the signal of 60 Hz (60 fields/sec, 30 frames/sec) and transmitted.

In this manner, the telecine signal is successively and repetitively formed every five fields, as a set, constructed by the two fields converted from the video image of the same frame (odd-number designated frame) and the three fields converted from the video image of the next same frame (even-number designated frame). Therefore, for example, since the third field Bo and the fifth field Bo in FIG. 2 are the same video signal, an interframe difference (difference between the frames) becomes zero. Since the eighth field De and the tenth field De are also the same video signal, an interframe difference also becomes zero. That is, when considering the interframe difference, the field in which the difference becomes zero every five fields occurs. Therefore, when the interframe difference is obtained, by detecting that the field in which the difference becomes zero occurs every five fields, the telecine signal can be identified. That is, the telecine detecting unit 42 detects the field which occurs every five fields and in which the interframe difference becomes zero. When such a field is repetitively detected, for example, a predetermined number of times (3 to 5 times), it is determined that the video signal inputted to the telecine IP converting circuit 4 is the telecine signal.

Further, the telecine detecting unit 42 also detects a telecine phase of the telecine signal. An example of the detection of the telecine phase will be described with reference to FIG. 3. A frame train of the telecine signal at the present time is shown in an upper frame train in FIG. 3. A 1V delay signal delayed by one-frame period of time (1V) and a 2V delay signal delayed by two-frame period of time (2V) are formed. For example, the telecine detecting unit 42 includes two frame memories, thereby forming three signals of the present signal (0V delay signal), 1V delay signal, and 2V delay signal. Subsequently, a difference (difference 1) between the 0V delay signal and the 1V delay signal and a difference (difference 2) between the 0V delay signal and the 2V delay signal are detected, respectively. The telecine phase is detected from a transition of “presence” and “absence” of the difference in the differences 1 and 2. The case where actual difference data is smaller than a predetermined value, the difference is assumed to be “absence” and it does not always mean that there is no actual difference data (0).

For example, when the difference is shifted from “absence” to “presence” in the difference 2 simultaneously with that the difference is shifted from “absence” to “presence” in the difference 1, “1” is allocated as a telecine phase. After that, for a period of time during which “presence” continues in the difference 2, if the difference is shifted from “absence” to “presence” in the difference 1, “2” is allocated as a telecine phase. When the difference is again shifted from “absence” to “presence” in the difference 1, “3” is allocated as a telecine phase. When the difference is again shifted from “absence” to “presence” in the difference 1, “4” is allocated as a telecine phase. If both of the difference 1 and the difference 2 are “absence”, “0” is allocated as a telecine phase.

In this manner, a telecine phase signal in which “0, 1, 2, 3, 4” is repeated as shown in the bottom portion of FIG. 3 is detected. Refer to, for example, JP-A-3-250881 (FIG. 7) or the like for the further details of the phase detection of the telecine signal.

When it is detected that the inputted video signal is the telecine signal of the interlace format of the 2-3 pull-down format, the telecine detecting unit 42 transmits a telecine detection F (telecine detection flag) showing the detection result and the telecine phase signal to the IP converting unit 41. When the inputted video signal is the telecine signal of the progressive format of the 2-3 pull-down format, the telecine detecting unit 42 does not execute the telecine detection.

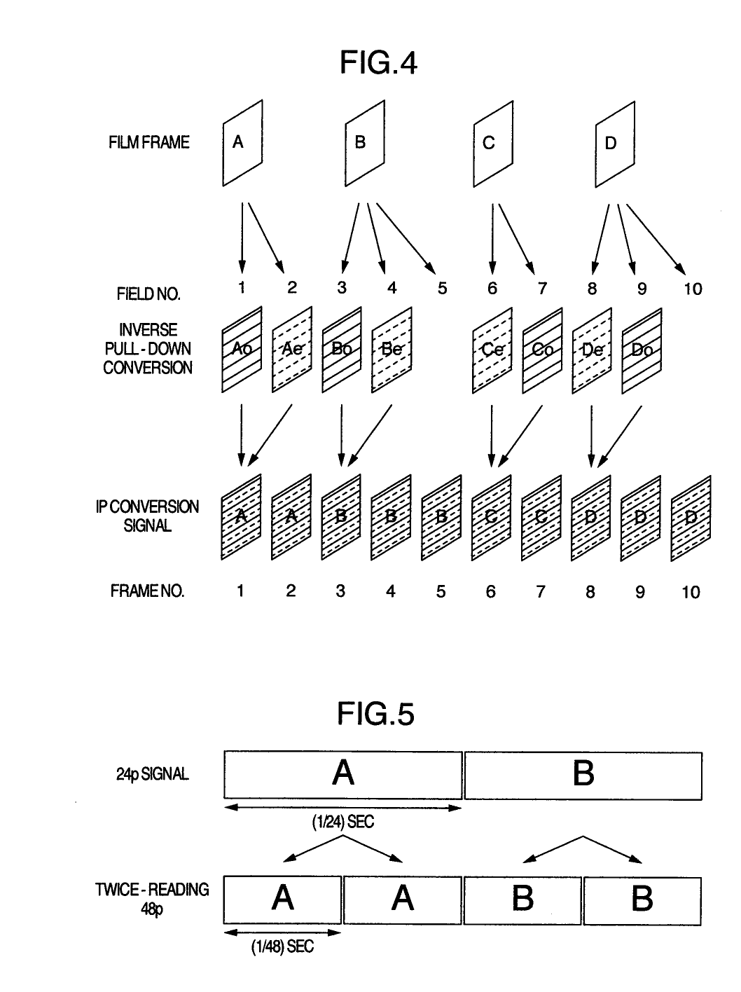

When the telecine detection F and the telecine phase signal are received, the IP converting unit 41 executes an IP conversion to the telecine signal. The operation of the IP converting operation will be described with reference to FIG. 4. FIG. 3 is a diagram for schematically describing the IP converting operation. When the telecine signal is inputted, as shown in FIG. 3, the IP converting unit 41 executes such an inverse pull-down converting process that, for example, the fields whose telecine phase signal indicates “2”, for example, the fifth field Bo and the tenth field De are deleted as overlap fields from, for example, the 2V delay signal. Subsequently, in the signal of the field train subjected to the inverse pull-down converting process, the first frame A is formed by inserting the first field Ao and the second field Ae and the first frame is repeated as for the second frame. Subsequently, the third frame B is formed by inserting the third field Bo and the fourth field Be and the third frame is repeated as for the fourth and fifth frames. In a manner similar to the above, the sixth frame C is formed by inserting the sixth field Ce and the seventh field Co and the sixth frame is repeated as for the seventh frame. The eighth frame D is formed by inserting the eighth field De and the ninth field Do and the eighth frame is repeated as for the ninth and tenth frames. In this manner, the telecine signal of the interlace format is converted into the signal of the progressive format and the converted signal is supplied to another contact of the switch 5.

When the input video signal is the 24p signal, the switch 5 selects the foregoing one contact, that is, the output signal from the HDMI receiver 2. When the input video signal is the telecine signal of the 2-3 pull-down format and the interlace format, the switch 5 selects the other contact, that is, the output signal from the telecine IP converting circuit 4 and outputs it to a scaler 6. Thus, the signal of the progressive format is always inputted to the scaler 6. The switch 5 is controlled by the CPU 151 of the control unit 15. When the video signal is transmitted by the HDMI interface, information regarding the format of the video signal is also transmitted from the external video reproducing apparatus 200. The HDMI receiver 2 receives the format information and outputs it to the CPU 151. When the format information from the HDMI receiver 2 indicates the progressive format, the CPU 151 selects one contact (output from the HDMI receiver 2) of the switch 5. When the format information indicates the interlace format, the CPU 151 selects the other contact (output from the telecine IP converting circuit 4).

The scaler 6 executes what is called a scaling process for magnifying or reducing a video image by interpolating pixels in the horizontal and vertical directions to the output signal from the switch 5 so as to obtain a resolution which can be displayed by a video display unit 14. The scaling-processed signal is supplied to a twice-reading circuit 7, a frame rate converting unit (FRC) 9, and a telecine detecting unit 8, respectively.

In the embodiment, it is assumed that the following two processes are executed as a process for converting the frame rate. One of them is a process in which the 24p signal or telecine signal is inversely telecine converted and the frame rate of the signal of the progressive format whose frame rate is equal to 24 Hz (hereinbelow, such a signal is referred to as “inverse telecine signal”) is doubled (48 Hz) by the twice-reading circuit 7. The other is a process in which the 24p signal or the inverse telecine signal is motion-compensated by the frame rate converting unit (FRC) 9 and its frame rate is converted into 60 Hz, thereby allowing the motion image to be seen as a smooth image. The former converting process is called a frame repeating process and the latter converting process is called a smooth cinema process.

Prior to explaining each converting process, first, the inverse telecine converting process will be described. The inverse telecine converting process is executed by the telecine detecting unit 8 and contents of fundamental processes are substantially the same as those of the telecine detecting unit 42 in the telecine IP converting circuit 4. However, besides the functions of the telecine detecting unit 42, a function for executing the inverse telecine conversion by using the telecine phase signal shown in FIG. 3 is added to the telecine detecting unit 8. For example, when the telecine phase signal shown in FIG. 3 is set to “0”, the frame which continues three times (for example, the frame A) is extracted from the 2V delay video image. When the telecine phase signal shown is set to “3”, the frame which continues twice (for example, the frame B) is extracted from the 2V delay video image. By this method, the inverse telecine signal of the progressive format whose frame rate is equal to 24 Hz can be obtained. The inverse telecine signal formed by the telecine detecting unit 8 is inputted to the twice-reading circuit 7 and the FRC 9, respectively.

Subsequently, the frame repeating process will be described. The twice-reading circuit 7 constructs a frame doubling unit. The twice-reading circuit 7 selects either the 24p signal or the inverse telecine signal in response to an instruction from the CPU 151 and doubles the frame rate. For example, the twice-reading circuit 7 is equipped with one frame memory. That is, the twice-reading circuit 7 holds data of one frame of the 24p signal or the inverse telecine signal, updates the data at a period of 1/24 second corresponding to the frame rate of the 24p signal, and reads out it at a period of 1/48 second that is twice as high as its updating period. Thus, as shown in FIG. 5, with respect to each of a plurality of frames included in the 24p signal, two frames whose video contents correspond to each frame are formed. In other words, the twice-reading circuit 7 forms every two frames of each frame of the 24p signal and the frame of the video contents, thereby converting the 24p signal or the inverse telecine signal into a 48p signal, that is, doubling the frame rate.

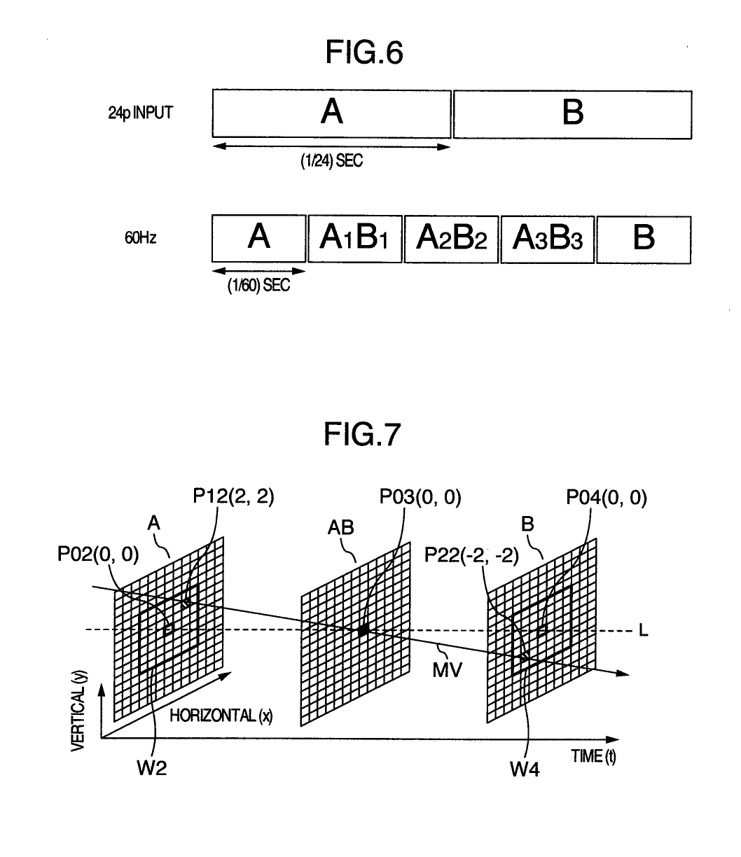

Subsequently, the smooth cinema process will be described. According to the smooth cinema process, as shown in FIG. 6, three interpolation frames A1B1, A2B2, and A3B3 subjected to a motion compensating process are inserted between the two frames A and B of the signal (24p input) of the progressive format whose frame rate is equal to 24 Hz, thereby converting the frame rate into 60 Hz. The smooth cinema process is executed by the FRC 9 and includes a process for roughly detecting a motion vector MV of a video image and a process for forming an interpolation frame AB by using the motion vector MV.

First, the detecting process of the motion vector MV will be described with reference to FIG. 7. In FIG. 7, t denotes a frame time direction. Coordinates of an interpolation pixel existing in the interpolation frame AB are conveniently assumed to be (0, 0).

First, search windows W2 and W4 showing a search range of the motion vector are set with respect to the frames A and B which time-dependently continue in the 24p input. The search window W2 of the frame A has a size of, for example, 7 pixels in the vertical direction and 7 pixels in the horizontal direction in which a pixel P02 of the frame A existing at the spatially same position as that of an interpolation pixel P03 is set to a center. Likewise, the search window W4 of the frame B also has a size of, for example, 7 pixels in the vertical direction and 7 pixels in the horizontal direction in which a pixel P04 of the frame B existing at the spatially same position as that of the interpolation pixel P03 is set to a center. Coordinates of the pixels P02 and P04 are also conveniently assumed to be (0, 0) for convenience of explanation.

Subsequently, a straight line which passes through the search window W2 of the frame A and the search window W4 of the frame B around the interpolation pixel P03 as a center is set. For example, assuming that the coordinates of the pixel existing at the left lower edge of the search window W2 are equal to (−3, −3), the pixel in the search window W4 existing on the straight line connecting the above pixel and the interpolation pixel P03 becomes the pixel at the right upper edge and its coordinates are equal to (3, 3). Such a straight line is set with respect to all pixels in the search windows W2 and W4. In this example, since the number of pixels in the search windows W2 and W4 is equal to 7×7=49, 49 straight lines are set as straight lines which pass through the interpolation pixel P03.

Subsequently, with respect to each of the 49 straight lines, a difference between the pixel in the search window W2 and the pixel in the search window W4 through which each straight line passes is calculated. It is assumed here that a difference between the luminance signals of each pixel is obtained. A straight line having a pair of pixels in which the difference is smallest is set as a motion vector of the interpolation pixel P03. In the example of FIG. 7, it is assumed that a difference of a pair of a pixel P12 (coordinates are (2, 2)) in the search window W2 and a pixel P22 (coordinates are (−2, −2)) in the search window W4 is smallest. Therefore, a straight line connecting the pixel P12, interpolation pixel P03, and pixel P22 is set as a motion vector MV of the interpolation pixel P03 (or pixel P12, pixel P22). That is, it is presumed that the pixel P12 of the frame A passes through the pixel existing at the same position as that of the interpolation pixel P03 of the interpolation frame AB and moves to the pixel P22 in the frame B along the direction shown by the motion vector MV. Although the motion vector is detected every pixel in the above example, it may be detected every block. For example, the motion vector may be detected by what is called a block matching method whereby each box of the search windows W2 and W4 is assumed to be a block constructed by N (N is equal to, for example, 4, 8, or 16) pixels in the horizontal direction and N pixels in the vertical direction and a pair of blocks in which the difference becomes minimum between the search windows W2 and W4 is obtained.

Subsequently, an interpolation frame forming process will be described. An interpolation frame is formed by using the motion vector MV detected as mentioned above and the frames A and B. For example, each video data of the pair of pixels (pixels P12 and P13) indicated by the detected motion vector MV is extracted from the video data of the frames A and B, each video data is multiplied by a predetermined coefficient, and the resultant data is added, thereby calculating a pixel value of an interpolation pixel or an interpolation block. Assuming that the predetermined coefficient is set to k here, the data of the interpolation pixel P03 is obtained by the following equation 1.

P03=(1−k)·P12+k·P22 (where, k<1) (1)

A value of k is decided by a ratio between a time-dependent distance between the interpolation frame AB and the frame A and a time-dependent distance between the interpolation frame AB and the frame B. For example, in the case of the interpolation frame A1B1, a ratio between the time-dependent distances for the frames A and B is equal to 1:2, k=⅓. In the case of the interpolation frame A2B2, a ratio between the time-dependent distances for the frames A and B is equal to 1:1, k=½. In the case of the interpolation frame A3B3, k=⅔.

The value of the interpolation pixel in the interpolation frame is obtained in this manner. By executing the above process with respect to all interpolation pixels, one interpolation frame is formed. By executing the above process with respect to all of the interpolation frames A1B1 to A3B3, three interpolation frames are formed. By inserting those interpolation frames between the frames A and B of the 24 p input, the 24 p input is frame-rate converted into the signal of 60 Hz as shown in FIG. 6. Since each interpolation frame is formed on the basis of the motion vector of the video image in this manner, the frame-rate converted signal is outputted as a motion-compensated signal of the smooth motion.

The signal subjected to the frame repeating process in the twice-reading circuit 7 and the signal subjected to the smooth cinema process in the FRC 9 are inputted to a cinema mode change-over switch 10, respectively. Further, a signal of the frame rate of 60 Hz obtained by executing, for example, the 2-3 pull-down process as shown in FIG. 2 to the 24p signal or inverse telecine signal by a telecine converting unit 18 is inputted to the cinema mode change-over switch 10. The cinema mode change-over switch 10 selects one of the three input signals on the basis of a signal from the CPU 151 and outputs.

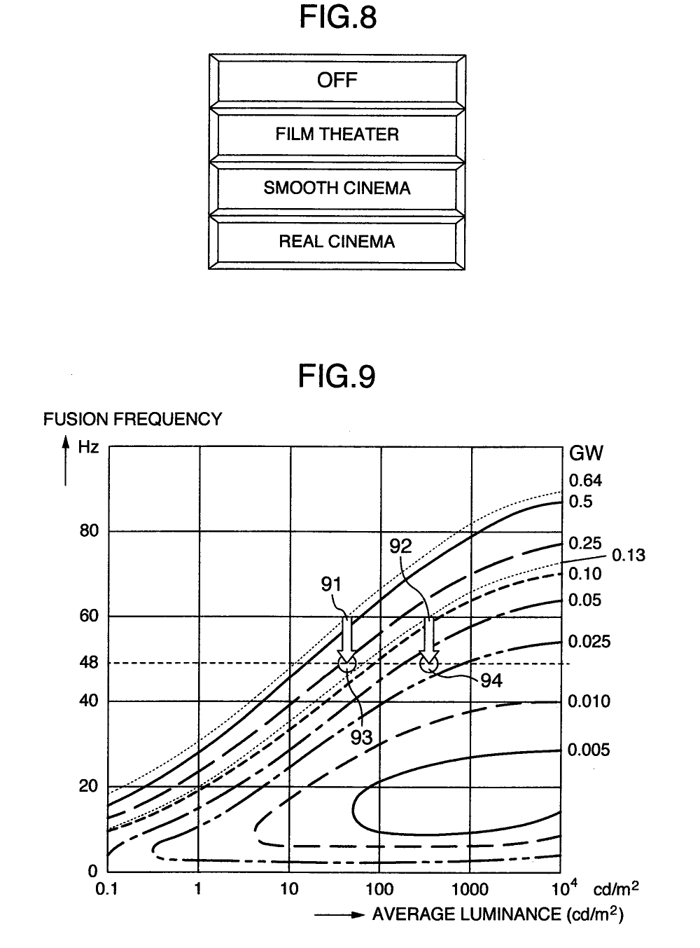

An output signal from the cinema mode change-over switch 10 is subjected to various kinds of picture quality correcting processes such as contrast correction, color correction, gamma correction, and the like by a picture quality correcting unit 11. After that, an OSD (On Screen Display) image such as a menu display screen or the like is synthesized by an OSD inserting circuit 12. An example of the OSD image is shown in FIG. 8. FIG. 8 shows the menu display screen for allowing the user to select a plurality of cinema modes and four selection items of “OFF”, “FILM THEATER”, “SMOOTH CINEMA”, and “REAL CINEMA” are displayed on the menu display screen. The selection by the user is performed by using a remote controller 16. When the operation for allowing the user to select a predetermined cinema mode is executed through the remote controller, the remote controller 16 transmits a remote controller signal based on the operation. A light receiving unit 152 in the control unit 15 receives the remote controller signal from the remote controller 16 and transmits it to the CPU 151. The CPU 151 analyzes the received remote controller signal in order to recognize that the remote controller signal includes a command for selecting which one of the cinema modes. The CPU 151 outputs a control signal based on an analysis result to the switch 10.

On the menu display screen of FIG. 8, “OFF” denotes a mode to turn off the cinema mode and is a mode to 2-3 pull-down process the 24 p signal or the inverse telecine signal by the telecine converting unit 18 and display the processed signal. “FILM THEATER” is a mode to execute substantially the same process as that in the case of “OFF” and display the processed signal when the input video signal is the 24p signal. However, when the input video signal is the signal of the interlace format, the IP converting process using the foregoing telecine phase signal is not executed by the telecine IP converting unit but a normal IP converting process is executed and the processed signal is displayed. As is well known, the normal IP converting process here is a process for calculating and forming data of a certain interpolation scanning line from scanning lines of front and rear fields (spatial positions are equal to that of the interpolation scanning line) which are time-dependently adjacent to a field where upper and lower scanning lines adjacent to the interpolation scanning line and/or the interpolation scanning line exist/exists. “SMOOTH CINEMA” is a mode to display the signal subjected to the smooth cinema process by the FRC 9. “REAL CINEMA” is a mode to display the video image on the basis of the SF formed by making the foregoing asymmetrical SF control to the signal subjected to the frame repeating process by the twice-reading circuit 7, and details of this mode will be described hereinafter.

That is, in the case where the input signal is the 24p signal or the inverse telecine signal, the cinema mode change-over switch 10 is controlled in such a manner that when “OFF” or “FILM THEATER” is selected by the user on the menu display screen of FIG. 8, the output signal from the telecine converting unit 18 is selected, when “SMOOTH CINEMA” is selected by the user, the output signal from the FRC 9 is selected, and when “REAL CINEMA” is selected by the user, the output signal from the twice-reading circuit 7 is selected, respectively.

The signal in which the OSD image has been inserted by the OSD inserting circuit is inputted to a subfield control circuit 13. The subfield control circuit 13 includes: an SF control unit 132 for executing a normal SF process such as a process to form and output fourteen SFs having different weights to one frame; and an asymmetrical SF control unit 131 for making the foregoing asymmetrical SF control.

A group of SF formed by the SF control unit 132 and a group of SF formed by the asymmetrical SF control unit 131 are supplied to an SF change-over switch 133, respectively. The SF change-over switch 133 selects one of those SF groups by a control signal from the CPU 151. The control signal from the CPU 151 is outputted in response to the cinema mode selected by the user. For example, the control signal for allowing the SF change-over switch 133 to select the SF group from the asymmetrical SF control unit 131 when “REAL CINEMA” is selected on the menu display screen of FIG. 8 and to select the SF group from the SF control unit 132 when the mode other than “REAL CINEMA” is selected is outputted.

The SF group outputted from the SF change-over switch 133 is supplied to the display unit 14 constructed by the PDP. The sustaining pulses (discharge maintaining pulses) of the number based on the SF group are applied to the discharge cells of the PDP 14, thereby allowing the gradation display to be performed on the display screen of the PDP 14.

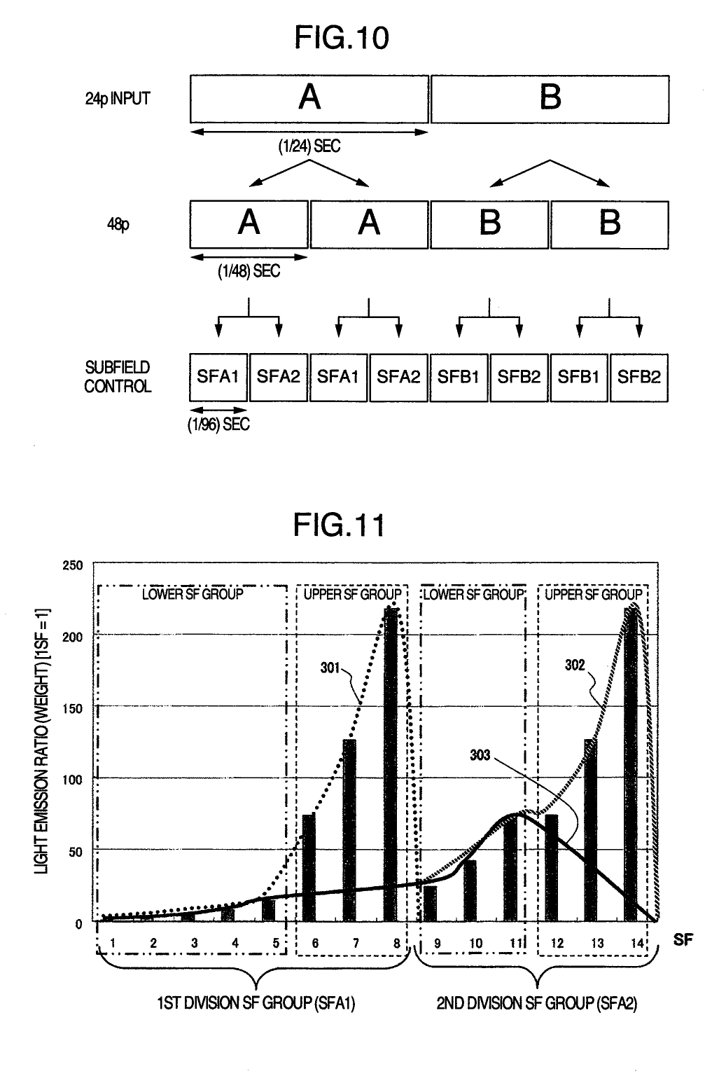

Subsequently, details of the SF control unit 132 as a characteristic portion of the embodiment will be described. Prior to explaining it, a concept or principle of the invention will be described with reference to FIGS. 9 and 10.

The human being feels flickering to a periodic fluctuation of the luminance. When a single pulse is first generated and, subsequently, a flickering frequency is gradually raised, although the human being feels the flickering first, the human being feels the flickering at a certain frequency and higher as a stationary average luminance. A frequency at which the flicker is fused to a predetermined luminance (that is, frequency at which the human being does not feel the flickering) is referred to as a flicker fusion frequency CFF (Critical Fusion Frequency or Critical Flicker Frequency) here. The CFF depends on the luminance of the light and, generally, there is such a tendency that the higher the luminance is, the higher the CFF is. FIG. 9 shows an example of characteristics showing a relation between the CFF and an average luminance. In FIG. 9, an axis of abscissa indicates the average luminance of the video image which is displayed by a logarithm expression. The left side of an axis of ordinate indicates the CFF and the right side of an axis of ordinate indicates a value called a fundamental wave quotient and it is referred to as GW here. The fundamental wave quotient GW is defined by ½ of a ratio of an amplitude of a fundamental wave to the average luminance in the case where the periodic fluctuation of the luminance is dissolved into each fundamental wave component by a Fourier development.

For example, a movie film whose frame rate is equal to 24 Hz is projected onto a screen at a rate of once per 48 seconds and at a duty ratio of 50% in a movie theater. Now assuming that the luminance changes in a range of 0 to 1, when the light emission in the case of a white display is Fourier transformed, the GW is equal to about 0.64.

In the case of displaying the 24p signal in the embodiment, since the signal of 24 Hz has been once converted into 48 Hz by the frame repeating process and inputted to the PDP, a fundamental frequency is equal to 48 Hz.

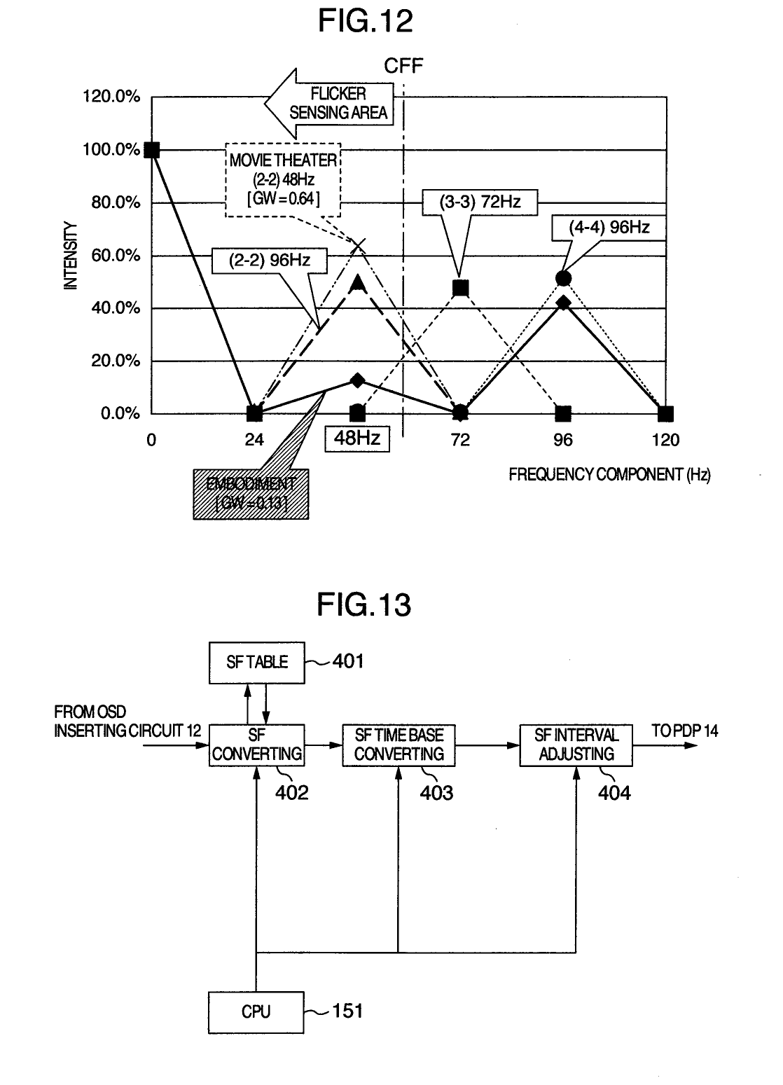

Further, the PDP is driven on a subfield (SF) unit basis, the numbers of light emitting times of the subfields SFs are made different, and the gradation expression is performed by a combination of them. At this time, in the case where the video signal of 48 Hz is inputted to the PDP and displayed as it is, for example, a frequency component whose intensity is strongest is lower than the CFF and its intensity is equal to about 50% and is a large value as shown in FIG. 12. In such a case, therefore, the flicker becomes fairly conspicuous. To solve such a problem, in the embodiment, as shown in FIG. 10, the SFs per frame are divided into two groups of a first division subfield group (SFA1, SFB1) and a second division subfield group (SFA2, SFB2). By this method, a driving frequency of the PDP is allowed to approach a driving frequency of 96 Hz which is twice as high as 48 Hz, thereby suppressing the large flicker (of 48 Hz).

However, when the viewer actually views in the movie theater, he slightly feels the flicker. This point will be explained with reference to FIG. 9 again. In FIG. 9, the relation between the average luminance and the CFF per GW is shown. If a point specified by the display luminance and the frequency of the fundamental wave is located under a characteristics curve of the GW, the viewer feels the flicker. If it exists above the curve, the viewer does not feel the flicker. In the case of the movie theater, GW=0.64 as mentioned above. A display luminance of a video image which is displayed on the screen in the movie theater is equal to about 48 cd/M² and a fundamental wave frequency of the video image is equal to 48 Hz. Therefore, a point 93 specified by the display luminance of 48 cd/M² and the fundamental wave frequency of 48 Hz is located under the curve of GW=0.64 as shown in FIG. 9. Consequently, the video image which is displayed on the screen in the movie theater exists in a region where the viewer can slightly feel the flicker. An arrow 91 in FIG. 9 indicates a magnitude of flicker. The longer this arrow is, the larger the viewer feels the flicker.

In the case of displaying the movie contents by the PDP, it is considered that if the viewer is made to visually sense a flicker similar to that in the case where the movie is actually viewed in the movie theater, the viewer can obtain a feeling as if he viewed in the movie theater although he is actually monitoring the movie by the PDP.

In the PDP, a flicker level can be changed by controlling the weight of the luminance of each SF (that is, light emitting times ratio), a time-dependent layout of each SF, a time-dependent interval between predetermined SFs, or the like. In the embodiment, therefore, by dividing the SFs per frame into the two groups and falsely driving the PDP at 96 Hz as mentioned above, the large flicker (of 48 Hz) is suppressed. On the other hand, the weight of the subfield group on the low gradation side (side where the weight is small) in the first division subfield group and the weight of the subfield group on the low gradation side (side where the weight is small) in the second division subfield group are made asymmetrical, thereby expressing the slight flicker which is sensed when the movie is viewed in the movie theater as mentioned above. By this method, a presence as if the viewer actually viewed the movie in the movie theater can be given to the viewer.

At this time, assuming that the weights of the first division subfield group and the second division subfield group are perfectly symmetrical, this is substantially equivalent to a state where the PDP is driven at 96 Hz, so that the PDP has to be driven by the SFs of the number which is half of the number of SFs upon driving at 48 Hz. If the number of SFs is small, since the number of combinations of them also decreases, such a method is disadvantageous in the case of performing the gradation expression. To solve such a problem, in the embodiment, in each of the first and second division subfield groups, the weights of the subfield groups on the high gradation side (side where the weight is large) in the division subfield groups are made symmetrical, thereby reducing the flicker, and the weights of the subfield groups on the low gradation side (side where the weight is small) in the division subfield groups are made asymmetrical, thereby expressing the slight flicker as mentioned above and enabling gradation expressing ability to be located in the middle between the 48 Hz driving and the 96 Hz driving. That is, according to the subfield control in the embodiment, in the case of the bright signal whose luminance level is high, since the flicker is conspicuous, symmetry is raised, and in the case of the dark signal whose luminance level is low, since the flicker is inconspicuous, symmetry is reduced. By making the SFs on the low gradation side asymmetrical, the sufficient gradations can be obtained in the movie contents including a large number of dark scenes.

An example of the asymmetrical SF control according to the embodiment is shown in FIG. 11. The asymmetrical SF control is executed when “REAL CINEMA” mentioned above is selected. It is assumed that the input signal is the 24p signal or the inverse telecine signal.

FIG. 11 shows an example of the first division subfield group SFA1 and the second division subfield group SFA2 corresponding to one frame A in the 48p signal shown in, for example, FIG. 10. In FIG. 11, an axis of abscissa indicates the number of the SF and an axis of ordinate indicates the light emission ratio (corresponding to the weight) of each SF. It is shown that the higher the light emission ratio is, the larger the weight is. In the embodiment, the total number of SFs of the SF group corresponding to one frame of the doubled signal is equal to 14. Those 14 SFs are divided into the first division subfield group SFA1 having eight SFs and the second division subfield group SFA2 having six SFs. Further, the first division subfield group SFA1 is classified into a lower SF group including the SFs of SF Nos. 1 to 5 on the side of the small weight (low gradation) and an upper SF group including the SFs of SF Nos. 6 to 8 on the side of the large weight (high gradation). Moreover, the second division subfield group SFA2 is classified into a lower SF group including the SFs of SF Nos. 9 to 11 on the side of the small weight (low gradation) and an upper SF group including the SFs of SF Nos. 12 to 14 on the side of the large weight (high gradation).

As will be obvious from FIG. 11, the upper SF groups on the side of the large weight are symmetrical between the first and second division SF groups, that is, the numbers of SFs belonging to the upper SF groups are the same and the weights of the SFs are equal. “Symmetrical” means here that the number of SFs belonging to the upper SF group of the first division SF group and the number of SFs belonging to the upper SF group of the second division SF group are equal and the weights of the luminance of those SF groups are the same. Further, a time interval between the SFs belonging to the upper SF group of the first division SF group and a time interval between the SFs belonging to the upper SF group of the second division SF group are also equal.

On the other hand, the lower SF groups on the side of the small weight are asymmetrical between the first and second division SF groups, that is, the numbers of SFs belonging to the lower SF groups are different and the weights of the SFs are also different. The weight of each of the SFs 9 to 11 belonging to the lower SF group of the second division SF group is set to be larger than the weight of each of the SFs 1 to 5 belonging to the lower SF group of the first division SF group. A time interval between the SFs belonging to the lower SF group of the first division SF group and a time interval between the SFs belonging to the lower SF group of the second division SF group may be also set to be different.

Envelopes of the weights of the SF groups formed as mentioned above are shown at 301 and 302 in FIG. 11. As will be obvious from those envelopes, although a shape of the first envelope 301 corresponding to the first division SF group and a shape of the second envelope 302 corresponding to the second division SF group are asymmetrical, shapes of them on the side of the upper SF groups of the large weight are symmetrical and shapes of them on the side of the lower SF groups of the small weight are asymmetrical. Further, an envelope of the weights of only the lower SF groups has a shape as shown at 303. When the SF groups (SF1 to SF5, SF9 to SF11) belonging to the lower SF group are extracted, the weight increases monotonously in the direction from SF1 to SF11. That is, in the embodiment, the weights of SF9 to SF11 are larger than those of SF1 to SF5 and, in the lower SFs, the minimum weight is added to SF1 and the maximum weight is added to SF11.

As will be obvious from profiles of those weight envelopes, with respect to one frame, two weight peaks are formed as shown by the first envelope 301 and the second envelope 302 regarding the upper SFs of the large weight, and one weight peak is formed as shown by the third envelope 303 regarding the lower SFs of the small weight.

That is, according to the asymmetrical SF control in the embodiment, the frequency of the high luminance is equal to 96 Hz due to the two peaks and the frequency of the low luminance is equal to 48 Hz due to the one peak. Frequency components of the video image displayed by those SF groups are shown in FIG. 12. As shown in FIG. 12, the video image displayed by the asymmetrical SF control according to the embodiment has the frequency component of 48 Hz and the frequency component of 96 Hz. The frequency component of 96 Hz is higher than the foregoing limit frequency CFF at which the viewer visually senses the flicker. Further, an intensity of the frequency component of 96 Hz is larger than that of the frequency component of 48 Hz. In addition, since the frequency component of 48 Hz of the same frequency as that of the movie is included although the intensity is small, the flicker which is sensed when the viewer actually views the movie in the movie theater is expressed. By this method, with respect to the bright portion where the flicker is conspicuous, the frequency is set to 96 Hz and the flicker is reduced, and with respect to the dark portion where the flicker is inconspicuous, the frequency is set to 48 Hz and the slight flicker is expressed. For reference, in FIG. 12, the frequency component of the video image by the signal obtained by 3-3 pull-down processing the 24p signal and setting the frame rate to 72 Hz and the frequency component of the video image by the signal obtained by 4-4 pull-down processing the 24p signal and setting the frame rate to 96 Hz are shown. In the case of the signal of 72 Hz and the signal of 96 Hz, although the frequency component of 72 Hz and the frequency component of 96 Hz are the main components and they are higher than the CFF, since the frequency component of 48 Hz is not contained, such a video image that the movie is actually viewed in the movie theater cannot be expressed.

The flicker characteristics in the embodiment to which the asymmetrical SF control has been made as mentioned above will be described with reference to FIG. 9 again. A value of the GW of the video image displayed by the SF groups as shown in FIG. 11 is equal to about 0.13 (when the video image whose signal level is maximum is displayed). Since a peak luminance of the ordinary PDP is equal to about a value within a range of 300 to 400 cd/M², a point 94 specified by the frequency of 48 Hz exists at a position smaller than the curve of GW=0.13, and the flicker occurs. However, a distance between the curve of GW=0.13 and the point 94 is as shown by an arrow 92 and has the same length as that of the arrow 91 in the case of the movie. That is, in the video image which is displayed by the embodiment, a flicker similar to that of the video image which is displayed in the movie theater occurs, and in the high luminance input whose input signal level is equal to 90 IRE or more, the movie contents is reproduced by an expression similar to that in the movie theater. Although the value of GW is set to 0.13 in the embodiment, the GW may be set to a value other than it. The weight of SF can be also controlled so that the value of GW is equal to, for example, 0.05 to 0.2.

As will be obvious from FIG. 11, the number of SFs which are used for the gradation expression is equal to 11 (that is, SF1 to SF5, SF9 to SF11, and SF6 to SF 8 (or SF12 to SF14)) in the embodiment. In the case of driving the PDP at 96 Hz, the number of SFs is equal to 7 and only up to 2⁷ (126) kinds of gradations can be expressed. In the embodiment, however, up to 2¹¹ (2048) kinds of gradation expressing ability can be assured.

As mentioned above, in the embodiment, both of the suppression of the flicker and the good gradation expression having a trade-off relation can be realized. Further, in the movie contents of 24p, a slightly low flicker similar to that of the movie which is displayed in the movie theater can be given. Therefore, according to the embodiment, in the “REAL CINEMA” mode, the gradation expression is improved while suppressing the large flicker and, further, the movie contents can be reproduced by an expression similar to that in the movie theater. In the “REAL CINEMA” mode, since a method whereby the telecine signal of the 2-3 pull-down format is displayed as in the “FILM THEATER” mode or the like is not used, the motion judder caused by the still period of time of the video image mentioned above is also reduced and the video image which can be easily seen can be provided. However, in the “REAL CINEMA” mode, since the frame rate is doubled by the frame repeating process and the motion compensation is not performed, a visual sense of discomfort may occur in the motion. However, in such a case, by selecting the foregoing “SMOOTH CINEMA” mode, the video contents can be viewed by the smooth motion. In the “SMOOTH CINEMA” mode, since the interpolation frame is formed by the motion vector of the video image, a correlation between the interpolation frame and the original video frame is absent or small depending on the motion of the video image, so that there is a case where a deterioration in picture quality occurs. In such a case, if the foregoing motion judder can be permitted, it is sufficient to select “OFF” or “FILM THEATER” mode as a cinema mode.

In the embodiment, 14 SFs are allocated to one frame and divided into the first division SF group having 8 SFs and the second division SF group having 6 SFs. However, the invention is not limited to such a dividing ratio. For instance, 11 SFs may be allocated to one frame and divided into the first division SF group having 6 SFs and the second division SF group having 5 SFs. Further, in the embodiment, in the division SF groups, the numbers of SFs of the upper SF groups are set to 3 and the numbers of SFs of the lower SF groups are set to 5 and 3. However, the invention is not limited to such numerical values. For instance, the numbers of SFs of the upper SF groups may be set to 2 and the numbers of SFs of the lower SF groups are set to 6 and 4. Further, the number of SFs of the first division SF group and the number of SFs of the second division SF group may be equalized and the numbers of SFs of the lower SF groups may be equalized between the first division SF group and the second division SF group. Naturally, those numbers of SFs can be also set to other numerical values. Moreover, in the embodiment, although the SFs are arranged in order from the larger weight with the elapse of time, they may be reversed.

Furthermore, in the embodiment, although the weights of the SFs belonging to the lower SF groups and/or the numbers of SFs are set to be asymmetrical between the first division SF group and the second division SF group, the time intervals between the SFs belonging to the lower SF groups may be set to be asymmetrical.

### Embodiment 2

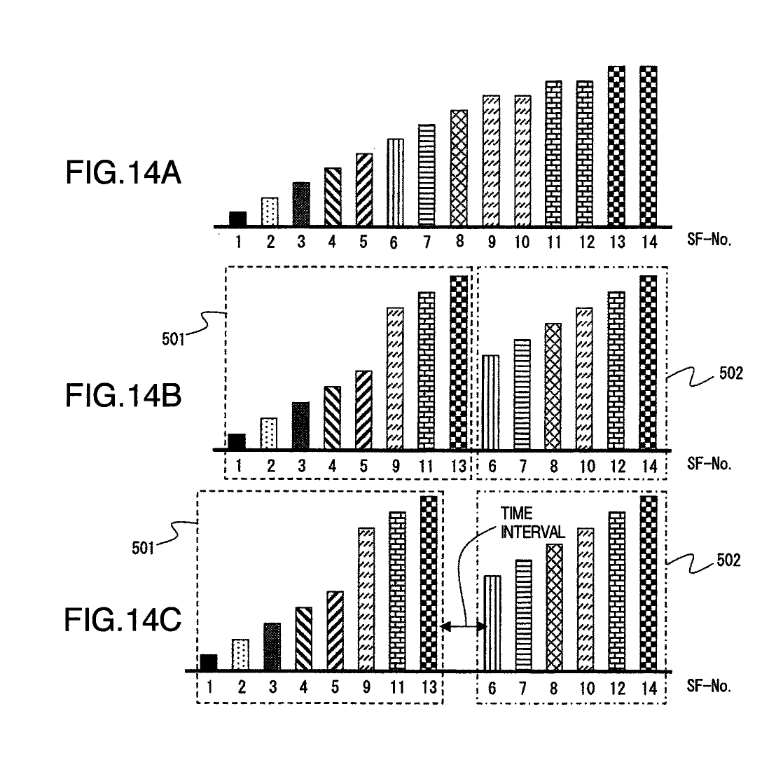

Subsequently, the second embodiment of the invention will be described with reference to FIGS. 13 and 14A to 14C. FIGS. 14A to 14C show other forms of the asymmetrical SF control unit 131. The signal from the OSD inserting circuit 12 is inputted to an SF converting circuit 402. Data regarding the number of stored SFs, the number of each SF, and the weight corresponding thereto has been stored in an SF table 401. The SF converting circuit 402 converts pixel data corresponding to each pixel of the signal from the OSD inserting circuit 12 into weight data in response to a control signal from the CPU 151 by using the various kinds of data regarding the SFs stored in the SF table 401, thereby forming an SF group as shown in FIG. 14A. The SF group shown in FIG. 14A is in a state where it is not yet divided into two division SF groups. The same weight has been added to each of the SF9 and SF10. Likewise, the same weight has been added to each of the SF11 and SF12. Similarly, the same weight has been added to each of the SF13 and SF14.

An SF time base converting circuit 403 rearranges the SF group outputted from the SF converting circuit 402 as shown in, for example, FIG. 14B. The layout order is controlled by a control signal from the CPU 151 and the rearranging control is made at one vertical period. In the rearrangement according to the embodiment, as shown in FIG. 14B, for example, the SF group is rearranged in such a manner that the SF9, SF11, and SF13 as an upper SF group are located after the SF1 to SF5 as a lower SF group, the SF6 to SF8 are further located after the SF9, SF11, and SF13, and the SF10, SF12, and SF14 are further located after the SF6 to SF8. In this manner, the SF group formed by the SF converting circuit 402 is divided into a first division SF group 501 and a second division SF group 502.

The SF group rearranged by the SF time base converting circuit 403 is inputted to an SF interval adjusting circuit 404, by which a time-dependent interval between the first division SF group 501 and the second division SF group 502 is controlled as shown in, for example, FIG. 14C. This interval is also controlled by a control signal from the CPU 151. A center of gravity of the weight of each of the first division SF group 501 and the second division SF group 502 (that is, a center of gravity of the time-dependent luminance of the light emitted in the SF group of one frame) is adjusted so as to be located to the optimum position by the SF interval adjusting circuit 404 and is supplied to the PDP 14. The intensity of flicker can be controlled by controlling the position of the center of gravity. The position of the center of gravity can be controlled by a control signal from the CPU 151, on the basis of, for example, an average luminance level of one frame of the input video signal or an average luminance level of the upper subfield group. For example, with respect to the frame of the high average luminance level, the flicker may be further suppressed by extending the time-dependent interval between the first division SF group 501 and the second division SF group 502, the frequency component of 96 Hz is raised. That is, by adjusting the weights of the SF group by the SF interval adjusting circuit 404, the value of GW mentioned above can be adjusted, so that the intensity of flicker can be controlled.

As mentioned above, in the embodiment, by controlling the time-dependent interval between the first division SF group 501 and the second division SF group 502 by the SF interval adjusting circuit 404, the intensity of flicker according to, for example, the brightness of the video image can be controlled and the expression which further conforms with the contents of the video image can be performed.

It should be further understood by those skilled in the art that although the foregoing description has been made on embodiments of the invention, the invention is not limited thereto and various changes and modifications may be made without departing from the spirit of the invention and the scope of the appended claims.

1. A plasma display apparatus having a plasma display panel for forming a plurality of subfields having different weights of luminance from a video signal of one frame and executing a gradation display on the basis of said plurality of subfields, comprising:
a frame rate converting unit for outputting a conversion signal whose frame rate has been at least doubled by forming at least two frames having video contents corresponding to each frame of the video signal; and
a subfield forming unit for forming a plurality of subfields corresponding to each frame of the conversion signal from said frame rate converting unit,
wherein said plurality of subfields corresponding to each frame of said conversion signal formed by said subfield forming unit are divided into a first division subfield group and a second division subfield group, each of said division subfield groups is further classified into an upper subfield group on the side where said weight is large and a lower subfield group on the side where said weight is small, and
said subfield forming unit equalizes said weights of said upper subfield groups between said first and second division subfield groups and makes said weight of each subfield belonging to said lower subfield group in said first division subfield group different from said weight of each subfield belonging to said lower subfield group in said second division subfield group.

2. A plasma display apparatus having a plasma display panel for forming a plurality of subfields having different weights of luminance from a video signal of one frame and executing a gradation display on the basis of said plurality of subfields, comprising:
a frame rate converting unit for outputting a conversion signal whose frame rate has been at least doubled by forming at least two frames having same video contents as those of each frame of the video signal; and
a subfield forming unit for forming a plurality of subfields corresponding to each frame of the conversion signal from said frame rate converting unit,
wherein said plurality of subfields corresponding to each frame of said conversion signal formed by said subfield forming unit are divided into a first division subfield group and a second division subfield group, each of said division subfield groups is further classified into an upper subfield group on the side where said weight is large and a lower subfield group on the side where said weight is small, and
said subfield forming unit makes said weights of said upper subfield group symmetrical between said first and second division subfield groups and makes said weight of each subfield belonging to said lower subfield group in said first division subfield group different from said weight of each subfield belonging to said lower subfield group in said second division subfield group, thereby making the weights of said lower subfield groups asymmetrical between said first and second division subfield groups.

3. An apparatus according to claim 1, wherein with respect to a plurality of frames in a cinema signal whose frame rate is equal to 24 Hz and which has been outputted from an external video reproducing apparatus or in a video signal whose frame rate is equal to 24 Hz and which has been obtained by inversely telecine-converting a telecine signal of a 2-3 pull-down format, said frame rate converting unit sequentially forms first and second frames having said same video contents and outputs said first and second frames, thereby converting the frame rate into 48 Hz.

4. An apparatus according to claim 2, wherein with respect to a plurality of frames in a cinema signal whose frame rate is equal to 24 Hz and which has been outputted from an external video reproducing apparatus or in a video signal whose frame rate is equal to 24 Hz and which has been obtained by inversely telecine-converting a telecine signal of a 2-3 pull-down format, said frame rate converting unit sequentially forms first and second frames having said same video contents and outputs said first and second frames, thereby converting the frame rate into 48 Hz.

5. An apparatus according to claim 3, wherein said frame rate converting unit includes:
a first converting mode for sequentially forming said first and second frames and outputting them with respect to said plurality of frames in said cinema signal or said inversely telecine-converted video signal, thereby converting the frame rate into 48 Hz; and
a second converting mode for inserting an interpolation frame formed on the basis of a motion of a video image into a frame train of said cinema signal or said inversely telecine-converted video signal, thereby converting the frame rate into 60 Hz.

6. An apparatus according to claim 4, wherein said frame rate converting unit includes:
a first converting mode for sequentially forming said first and second frames and outputting them with respect to said plurality of frames in said cinema signal or said inversely telecine-converted video signal, thereby converting the frame rate into 48 Hz; and
a second converting mode for inserting an interpolation frame formed on the basis of a motion of a video image into a frame train of said cinema signal or said inversely telecine-converted video signal, thereby converting the frame rate into 60 Hz.

7. An apparatus according to claim 5, wherein when said frame rate converting unit executes the frame rate conversion by said second converting mode, said subfield forming unit does not execute a process using said first and second division subfield groups.

8. An apparatus according to claim 6, wherein when said frame rate converting unit executes the frame rate conversion by said second converting mode, said subfield forming unit does not execute a process using said first and second division subfield groups.

9. An apparatus according to claim 5, wherein said first converting mode and said second converting mode can be selected by using a menu image displayed on a display screen of said plasma display panel.

10. An apparatus according to claim 6, wherein said first converting mode and said second converting mode can be selected by using a menu image displayed on a display screen of said plasma display panel.

11. An apparatus according to claim 1, wherein the number of subfields in said upper subfield group is equal to or less than the number of subfields in said lower subfield group.

12. An apparatus according to claim 2, wherein the number of subfields in said upper subfield group is equal to or less than the number of subfields in said lower subfield group.

13. An apparatus according to claim 1, wherein the number of subfields belonging to said first division subfield group and the number of subfields belonging to said second division subfield group are different.

14. An apparatus according to claim 2, wherein the number of subfields belonging to said first division subfield group and the number of subfields belonging to said second division subfield group are different.

15. An apparatus according to claim 1, wherein the number of subfields belonging to said lower subfield group in said first division subfield group and the number of subfields belonging to said lower subfield group corresponding to said second frame are different.

16. An apparatus according to claim 2, wherein the number of subfields belonging to said lower subfield group in said first division subfield group and the number of subfields belonging to said lower subfield group corresponding to said second frame are different.

17. An apparatus according to claim 1, wherein said first division subfield group is formed later than said second division subfield group with respect to time, and the number of subfields of said lower subfield group corresponding to said first division subfield group is equal to or less than the number of subfields of said lower subfield group corresponding to said second division subfield group.

18. An apparatus according to claim 2, wherein said first division subfield group is formed later than said second division subfield group with respect to time, and the number of subfields of said lower subfield group corresponding to said first division subfield group is equal to or less than the number of subfields of said lower subfield group corresponding to said second division subfield group.

19. An apparatus according to claim 1, wherein the weight of each subfield belonging to the lower subfield group corresponding to each of said first and second division subfield groups has one peak.

20. An apparatus according to claim 2, wherein the weight of each subfield belonging to the lower subfield group corresponding to each of said first and second division subfield groups has one peak.

21. A plasma display apparatus having a plasma display panel for forming a plurality of subfields having different weights of luminance from a video signal of one frame and executing a gradation display on the basis of said plurality of subfields, comprising:
a frame rate converting unit for outputting a conversion signal whose frame rate has been at least doubled by forming at least two frames having video contents corresponding to each frame of the video signal; and
a subfield forming unit for forming a plurality of subfields corresponding to each frame of the conversion signal from said frame rate converting unit,
wherein said plurality of subfields corresponding to each frame of said conversion signal formed by said subfield forming unit are divided into a first division subfield group and a second division subfield group, each of said division subfield groups is further classified into an upper subfield group on the side where said weight is large and a lower subfield group on the side where said weight is small, and
said subfield forming unit controls the weights of said subfields in such a manner that in one frame of said conversion signal,
a peak of said weight to said upper subfield group is formed in correspondence to each of said first and second subfield groups, and
one peak of said weight to said lower subfield group is formed.

22. An apparatus according to claim 21, wherein
said weight of each subfield belonging to said upper subfield group in said first division subfield group and said weight of each subfield belonging to said upper subfield group in said second division subfield group are equalized, thereby allowing the peak of said weight in said upper subfield group to be formed one by one for said first and second subfield groups, and
said weight of each subfield belonging to said lower subfield group in said first division subfield group is set to be larger than that in said second division subfield group, thereby allowing one peak of said weight in said lower subfield group to be formed between said first and second subfield groups.
